(19) United States
(12) Patent Application Publication
(10) Pub. No.: US 2023/0137436 A1
(43) Pub. Date: May 4, 2023

(54) DATA PRIVACY PRESERVATION IN OBJECT STORAGE

(71) Applicant: RED HAT, INC., Raleigh, NC (US)

(72) Inventors: Huamin Chen, Westford, MA (US); Michael Hingston McLaughlin Bursell, Essex (GB); Yuval Lifshitz, Kfar HaOranim (IL)

(21) Appl. No.: 17/513,209

(22) Filed: Oct. 28, 2021

(51) Int. Cl. G06F 21/62; G06F 21/53; G06F 21/57; G06N 20/00

(52) U.S. Cl. CPC G06F 21/6254; G06F 21/53; G06F 21/57; G06N 20/00

(57) ABSTRACT

A method includes receiving data uploaded to a storage system from a client device and in response to receiving the data, instantiating a serverless function for anonymizing the data uploaded to the storage system. The method further includes retrieving, by the serverless function, an anonymization model to anonymize the data uploaded to the storage system and applying the anonymization model to the data uploaded to the storage system to generate anonymized data.

### TECHNICAL FIELD

Aspects of the present disclosure relate to cloud data storage, and more particularly, to data privacy preservation in object storage.

### BACKGROUND

Cloud storage may include data storage at a third-party storage system such as a cloud computing provider or cloud computing platform. Object storage may include data storage that stores data as objects. A serverless function system may be executed by a cloud computing system for performing a service or executing a workload. The cloud computing system may dynamically manage the allocation and provisioning of serverless functions on servers of the cloud computing system in view of a computing workload. The serverless functions may be execution environments for the performance of various functions.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram that illustrates an example computer architecture, in accordance with some embodiments.

FIG. 2 is an illustration of an example of a computer system architecture for data anonymization to preserve data privacy in a cloud storage system, in accordance with embodiments of the disclosure.

FIG. 3 depicts an example system for data anonymization in a cloud storage system, in accordance with some embodiments.

FIG. 4 depicts another example system for data anonymization in a cloud storage system, in accordance with some embodiments.

FIG. 5 is a flow diagram of a method of data anonymization in cloud storage, in accordance with some embodiments.

FIG. 6 is a flow diagram of another method of data anonymization in cloud storage, in accordance with some embodiments.

FIG. 7 is a flow diagram of another method of data anonymization in cloud storage, in accordance with some embodiments.

FIG. 8 is a block diagram of an example apparatus that may perform one or more of the operations described herein, in accordance with some embodiments of the present disclosure.

### DETAILED DESCRIPTION

Data privacy concerns are prevalent in cloud storage systems or any third-party provided data storage because control of the data is left to the storage provider. Data privacy protection issues may arise in edge computing workloads, such as vehicle to everything (V2X), video streaming, and content delivery networks. Preservation of data privacy in storage systems may be mandated by users or even by laws of some countries. For example, many jurisdictions may have rules or laws regarding maintaining the privacy of data collected from users, such as removing or anonymizing personal or other sensitive information. The anonymization of data by an end user (e.g., before upload to a data storage system) may take numerous computing resources as well as compliance aware filters on the end user device, which may be prohibitive and expensive. On the other hand, outsourcing data privacy preservation to service providers may create security concerns regarding proprietary models for anonymizing data, and any sensitive business information of the end user or personal user information. For example, the models may be provided to the service provider resulting in loss of control of the models which the service provider may allow to be compromised or leaked from unprotected environments.

Aspects of the present disclosure address the above-noted and other deficiencies by providing a data privacy preservation platform to automatically detect and anonymize data uploaded from an end user to a cloud storage system. In some embodiments, an end user may upload their anonymization models (e.g., machine learning models) to a private data bucket in a cloud storage system. The anonymization models may anonymize one or more particular types of data uploaded by the end user. In some embodiments, processing logic may detect when the end user uploads data objects to a data bucket in the cloud storage system associated with the end user. Upon detecting that the end user has uploaded one or more data objects, the processing logic may invoke a serverless function for anonymizing the data objects. In some examples, the processing logic may generate a trusted execution environment in which to execute the serverless function to ensure security of the anonymization models as well as the uploaded data.

In some examples, the serverless function may retrieve the one or more anonymization models uploaded by the end user and apply the models to the uploaded data objects to anonymize the data objects. In some examples, the processing logic may provide the serverless function with credentials (e.g., user provided credentials) for accessing the private data bucket storing the anonymization models from the end user. The serverless function may then persist the anonymized data objects in the designated data buckets associated with the end user in the cloud storage system.

Providing the data privacy preservation platform to invoke the serverless function within a trusted execution environment may ensure the privacy of data uploaded to the cloud storage platform while also providing for security of the data and proprietary information of the end user's anonymization models. Additionally, the invocation of serverless functions to anonymize data provides for the flexibility to scale computing resources provided for anonymizing data as data is uploaded to the cloud storage system.

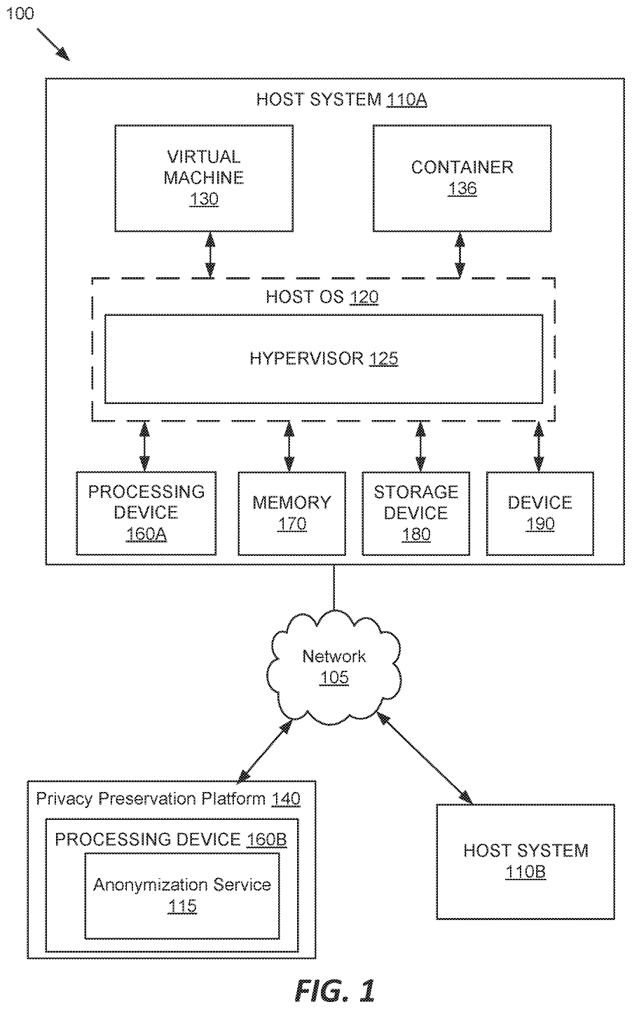

FIG. 1 depicts a high-level component diagram of an illustrative example of a computer system architecture 100, in accordance with one or more aspects of the present disclosure. One skilled in the art will appreciate that other computer system architectures are possible, and that the implementation of a computer system utilizing examples of the invention are not necessarily limited to the specific architecture depicted by FIG. 1.

As shown in FIG. 1, computer system architecture 100 includes host systems 110A-B and privacy preservation platform 140. The host systems 110A-B and privacy preservation platform 140 include one or more processing devices 160A-B, memory 170, which may include volatile memory devices (e.g., random access memory (RAM)), non-volatile memory devices (e.g., flash memory) and/or other types of memory devices, a storage device 180 (e.g., one or more magnetic hard disk drives, a Peripheral Component Interconnect [PCI] solid state drive, a Redundant Array of Independent Disks [RAID] system, a network attached storage [NAS] array, etc.), and one or more devices 190 (e.g., a Peripheral Component Interconnect [PCI] device, network interface controller (NIC), a video card, an I/O device, etc.). In certain implementations, memory 170 may be non-uniform access (NUMA), such that memory access time depends on the memory location relative to processing devices 160A-B. It should be noted that although, for simplicity, host system 110A is depicted as including a single processing device 160A, storage device 180, and device 190 in FIG. 1, other embodiments of host systems 110A may include a plurality of processing devices, storage devices, and devices. Similarly, privacy preservation platform 140 and host system 110B may include a plurality of processing devices, storage devices, and devices. The host systems 110A-B and privacy preservation platform 140 may each be a server, a mainframe, a workstation, a personal computer (PC), a mobile phone, a palm-sized computing device, etc. In embodiments, host systems 110A-B and privacy preservation platform 140 may be separate computing devices. In some embodiments, host systems 110A-B and/or privacy preservation platform 140 may be implemented by a single computing device. For clarity, some components of privacy preservation platform 140 and host system 110B are not shown. Furthermore, although computer system architecture 100 is illustrated as having two host systems, embodiments of the disclosure may utilize any number of host systems.

Host system 110A may additionally include one or more virtual machines (VMs) 130, containers 136, and host operating system (OS) 120. VM 130 is a software implementation of a machine that executes programs as though it were an actual physical machine. Container 136 acts as an isolated execution environment for different functions of applications. The VM 130 and/or container 136 may be an instance of a serverless application or function for executing one or more applications of a serverless framework. Host OS 120 manages the hardware resources of the computer system and provides functions such as inter-process communication, scheduling, memory management, and so forth.

Host OS 120 may include a hypervisor 125 (which may also be known as a virtual machine monitor (VMM)), which provides a virtual operating platform for VMs 130 and manages their execution. Hypervisor 125 may manage system resources, including access to physical processing devices (e.g., processors, CPUs, etc.), physical memory (e.g., RAM), storage device (e.g., HDDs, SSDs), and/or other devices (e.g., sound cards, video cards, etc.). The hypervisor 125, though typically implemented in software, may emulate and export a bare machine interface to higher level software in the form of virtual processors and guest memory. Higher level software may comprise a standard or real-time OS, may be a highly stripped down operating environment with limited operating system functionality, and/or may not include traditional OS facilities, etc. Hypervisor 125 may present other software (i.e., “guest” software) the abstraction of one or more VMs that provide the same or different abstractions to various guest software (e.g., guest operating system, guest applications). It should be noted that in some alternative implementations, hypervisor 125 may be external to host OS 120, rather than embedded within host OS 120, or may replace host OS 120.

The host systems 110A-B and privacy preservation platform 140 may be coupled (e.g., may be operatively coupled, communicatively coupled, may communicate data/messages with each other) via network 105. Network 105 may be a public network (e.g., the internet), a private network (e.g., a local area network (LAN) or wide area network (WAN)), or a combination thereof. In one embodiment, network 105 may include a wired or a wireless infrastructure, which may be provided by one or more wireless communications systems, such as a WiFi′ hotspot connected with the network 105 and/or a wireless carrier system that can be implemented using various data processing equipment, communication towers (e.g., cell towers), etc. The network 105 may carry communications (e.g., data, message, packets, frames, etc.) between the various components of host systems 110A-B and/or privacy preservation platform 140. In some embodiments, host system 110A and 110B may be a part of privacy preservation platform 140. For example, the virtual machines 130 and/or containers 136 of host system 110A and 110B may be a part of a virtual network of the privacy preservation platform 140.

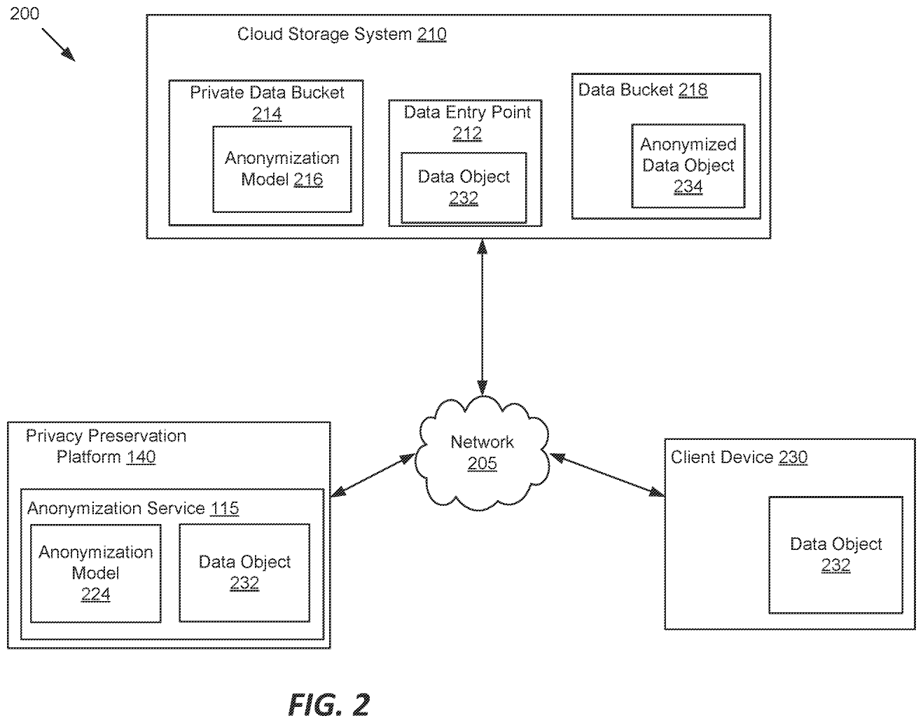

In embodiments, processing device 160B of the privacy preservation platform 140 may execute an anonymization service 115. The privacy preservation platform 140 may be a container orchestration system or other serverless management system and anonymization service 115 may be a serverless function. The privacy preservation platform 140 may invoke the anonymization service 115 in response to determining that data has been uploaded to a data storage system (e.g., a cloud storage system) associated with the privacy preservation platform 140. The anonymization service 115 may retrieve an anonymization model (e.g., a machine learning model trained to remove or anonymize certain data from a data object) and the uploaded data from the data storage system. The anonymization service 115 may apply the anonymization model to the uploaded data to anonymize the data. In some examples, the anonymization service 115 may be executed in a trusted execution environment to provide for security of the anonymization model and the uploaded data. For example, the anonymization service 115 may be executed in a TEE of a TEE-enabled virtual machine or container. One or more additional anonymization services may be instantiated within the virtual machine or container to scale the anonymization of uploaded data based on the amount of data uploaded to the data storage system. The anonymization service 115 may then store the anonymized data at the data storage system. Further details regarding the anonymization service 115 will be discussed at FIGS. 2-7 below.

FIG. 2 depicts an example of a system 200 for data privacy preservation in a data storage system, in accordance with embodiments of the disclosure. The system 200 includes a cloud storage system 210, a privacy preservation platform 220, and a client device 230. Although depicted as separate, the cloud storage system 210 and the privacy preservation platform 220 may be included in the same platform. The cloud storage system 210 may include one or more data buckets 218 for storing data uploaded to the cloud storage system 210. For example, the client device 230 may upload a data object 232 to the cloud storage system 210. The data object 232 may be uploaded at a data entry point 212 (e.g., via an API of the cloud storage system 210).

In some examples, the data object 232 may be anonymized prior to being stored at the cloud storage system 210. For example, upon receiving the data object 232 at the entry point 212, the cloud storage system 210 may invoke anonymization service 115 at the privacy preservation platform 220. The anonymization service 115 may retrieve an anonymization model 216 from a private data bucket 214 and the data object from the data entry point 212. In some examples, the cloud storage system 210 may store the data object 232 in a temporary storage bucket to be retrieved by the anonymization service 115. Alternatively, the cloud storage system 210 may provide the data object 232 directly to the anonymization service 115 (e.g., synchronously) without first storing the data object 232 at the cloud storage system. In some examples, the data object 232 may be buffered in memory of the cloud storage system 210. After retrieving the anonymization model 224 and data object 232, the anonymization service 115 may apply the anonymization model 224 to the data object 232 to anonymize the data object 232. For example, the anonymization model 224 may identify and remove one or more portions of information (e.g., sensitive or private information) from the data object 232. The anonymization service 115 may provide the anonymized data object 234 to a data bucket 218 of the cloud storage system 210. The data bucket 218 may be associated with the client device 230 or user of the client device 230.

In some examples, the privacy preservation platform 220 or other serverless engine may generate or retrieve credentials to access the private data bucket 214. The privacy preservation platform 220 may then provide the credentials to the anonymization server 115 for the anonymization service 115 to retrieve the anonymization model 216 from the private data bucket 214. The privacy preservation platform 220 may also generate a trusted execution environment, such as a secure container, virtual machine, etc. for executing the anonymization service 115. The anonymization service 115 may retrieve the anonymization model 216 and the data object 232 to anonymize the data object 232 within the trusted execution environment.

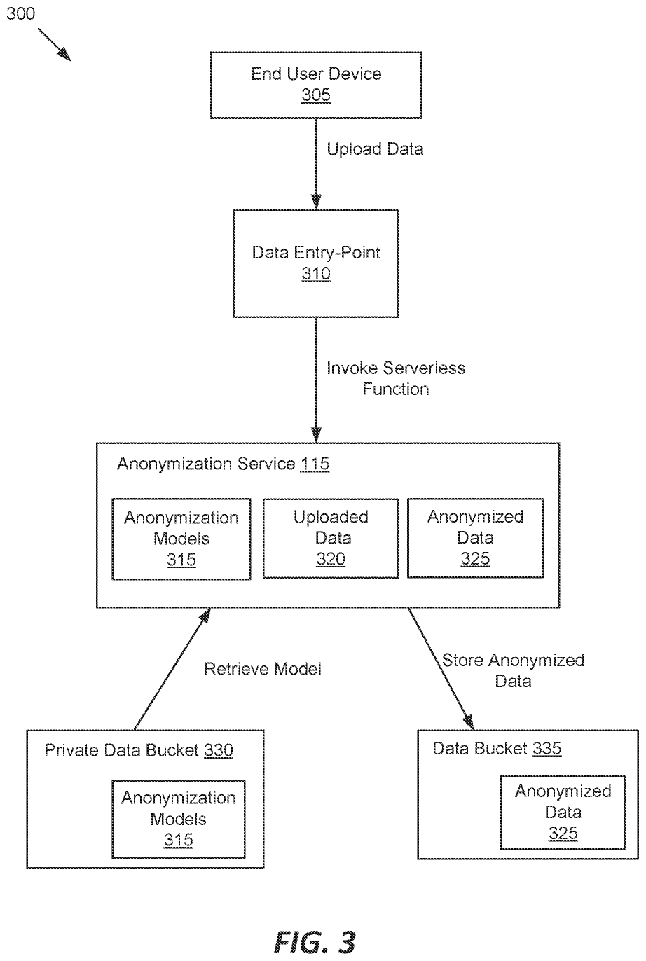

FIG. 3 is an example of a system 300 for secure and scalable anonymization of data in a data storage system, in accordance with embodiments of the disclosure. The system 300 may include an end user device 305 to upload data (e.g., a data object) to a data storage system, such as a cloud storage system. In one example, the end user device 305 may upload the data to a data entry-point 310 of the data storage system. In some examples, the data entry-point 310 or a privacy preservation platform (e.g., privacy preservation platform 140) associated with the data entry-point 310 may detect the uploaded data at the data entry-point 310 of the data storage system and invoke a serverless function (e.g., anonymization service 115) for anonymizing the uploaded data. In some examples, the privacy preservation platform may prepare a TEE (e.g., in a TEE enabled virtual machine) in which to execute the anonymization service 115. In some examples, the anonymization service 115 may retrieve one or more anonymization models 315 from a private data bucket 330 of the data storage system and apply the anonymization models 315 to the uploaded data 320 to generate anonymized data 325. For example, the anonymization models 315 may identify and remove or otherwise obfuscate sensitive information included in the uploaded data.

In the depicted example, the uploaded data may not be stored at the data storage system until the data is anonymized by the anonymization service 115. In some examples, the anonymization service 115 may synchronously anonymize the uploaded data 320 as it is uploaded and then store the anonymized data 325 to a data bucket 335 of the data storage system associated with the end user device 305. For example, the uploaded data 320 may be redirected to the anonymization service 115 to be anonymized prior to storing the uploaded data 320 at the data storage system.

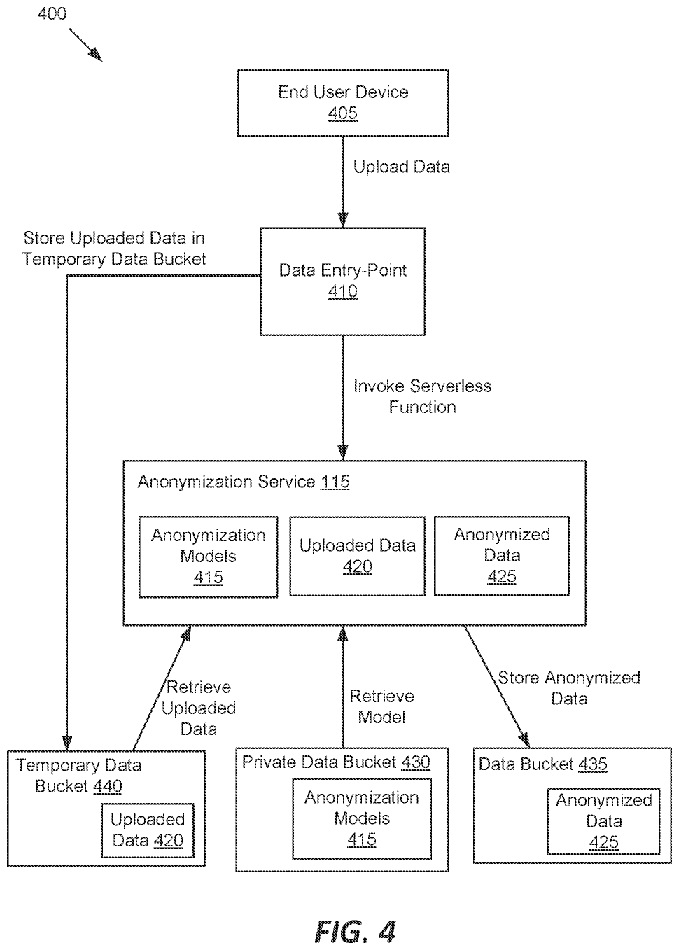

FIG. 4 is an example of a system 400 for secure and scalable anonymization of data in a data storage system, in accordance with embodiments of the disclosure. The system 400 may include an end user device 405 to upload data (e.g., a data object) to a data storage system, such as a cloud storage system. In one example, the end user device 405 may upload the data to a data entry-point 410 of the data storage system. In some examples, the data entry-point 410 or a privacy preservation platform (e.g., privacy preservation platform 140) associated with the data entry-point 410 may detect the uploaded data at the data entry-point 410 of the data storage system and invoke a serverless function (e.g., anonymization service 115) for anonymizing the uploaded data. In some examples, the privacy preservation platform may prepare a TEE (e.g., in a TEE enabled virtual machine) in which to execute the anonymization service 115. In some examples, the anonymization service 115 may retrieve one or more anonymization models 415 from a private data bucket 430 of the data storage system and apply the anonymization models 415 to the uploaded data 420 to generate anonymized data 425.

In the depicted example, the uploaded data 420 may be stored in a temporary data bucket 440 in memory of the data storage system or other short term storage. For example, the temporary data bucket 440 may allow the data to be stored temporarily at the data storage system for the anonymization service 115 to asynchronously anonymize the uploaded data 420 rather than waiting for the uploaded data to be anonymized before storing the data.

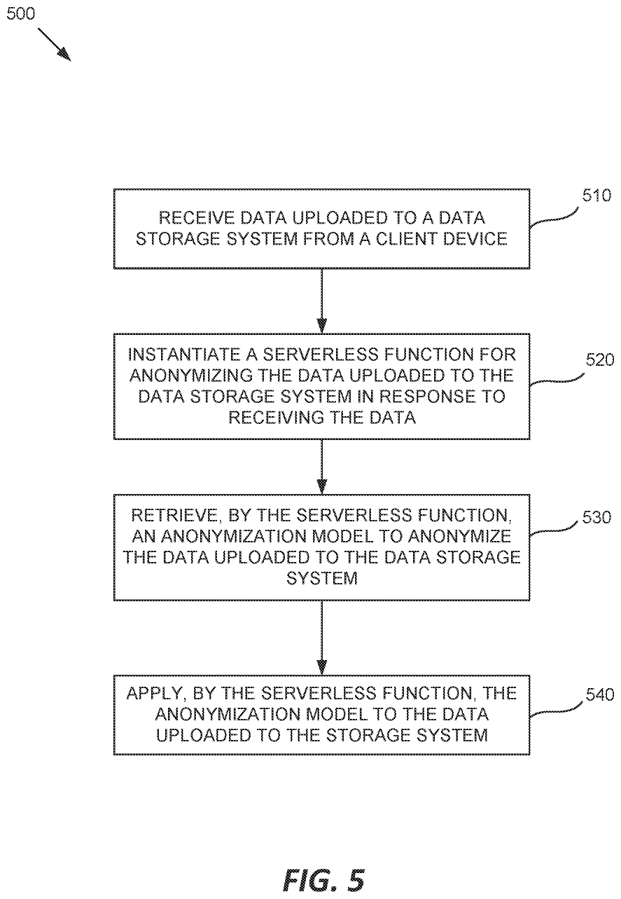

FIG. 5 is a flow diagram of a method 500 of secure and scalable data anonymization and data protection in a data storage system, in accordance with some embodiments. Method 500 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, at least a portion of method 500 may be performed by anonymization service 115 of privacy preservation platform 140 of FIG. 1.

With reference to FIG. 5, method 500 illustrates example functions used by various embodiments. Although specific function blocks (“blocks”) are disclosed in method 500, such blocks are examples. That is, embodiments are well suited to performing various other blocks or variations of the blocks recited in method 500. It is appreciated that the blocks in method 500 may be performed in an order different than presented, and that not all of the blocks in method 500 may be performed.

Method 500 begins at block 510, where the processing logic receives data uploaded to a data storage system from a client device. The data may include sensitive or private information associated with an end user, client of the end user, or other entity associated with the end user (e.g., data collected from sensors of an automated driving vehicle). In some instances, the sensitive or private information may not be stored at the data storage system due to security concerns, local laws, etc. In some examples, the sensitive or private information may require anonymization (e.g. pixelation or blurring of sensitive data in an image, removing of personal identifying information from a document, etc.) before being stored at the data storage system.

At block 520, the processing logic instantiates a serverless function for anonymizing the data uploaded to the data storage system in response to receiving the data. In order to anonymize the uploaded data, the serverless function is invoked once data is uploaded so the data can be anonymized prior to being stored at the data storage system. For example, the processing logic may identify that data has been received from a particular client device or end user. The client device or end user may own or be associated with one or more data buckets in the data storage system. Additionally, the client device or end user may also be associated with a private data bucket to which anonymization models for anonymizing data uploaded by the client device or end user.

At block 530, the processing logic retrieves, by the serverless function, an anonymization model to anonymize the data uploaded to the data storage system. Once instantiated, the serverless function may identify which private bucket is associated with the end user and retrieve one or more anonymization models from the private bucket. In some examples, the processing logic may provide the serverless function with credentials (e.g., end user provided credentials) for accessing the private bucket of the end user to retrieve the anonymization models.

At block 540, the processing logic applies, by the serverless function, the anonymization model to the data uploaded to the data storage system. The processing logic may apply each of the one or more anonymization models retrieved from the private bucket. Each anonymization model may remove a type of information from the uploaded data. For example, a first anonymization model may be applied to an image that is uploaded to remove a particular type of information (e.g., vehicle license plates, faces, or other personal information), a second anonymization model may remove a different type of information, etc. Once the data has been anonymized, the processing logic may store the anonymized data at the data storage system in the data buckets associated with the end user.

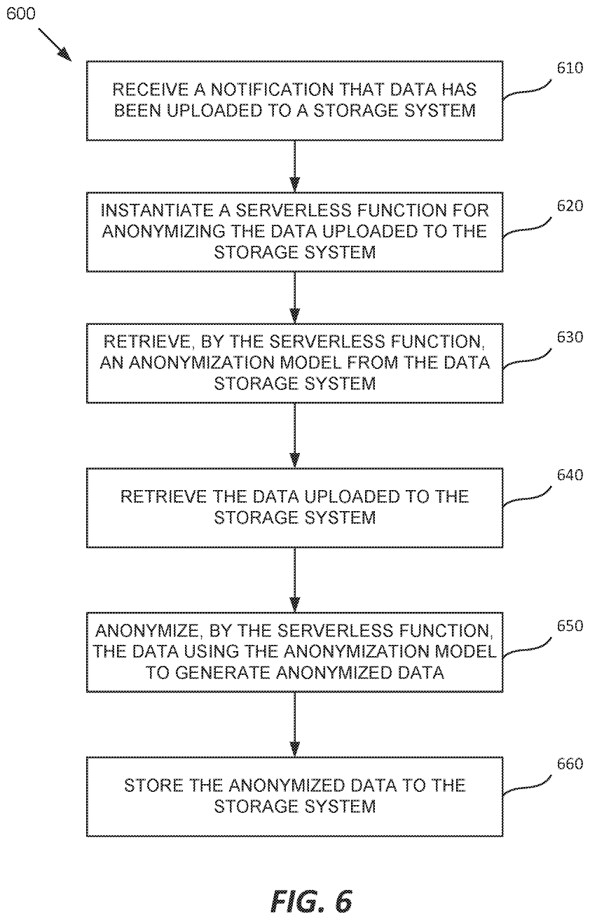

FIG. 6 is a flow diagram of a method 600 of secure and scalable data anonymization and data protection in a data storage system, in accordance with some embodiments. Method 600 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, at least a portion of method 600 may be performed by anonymization service 115 of privacy preservation platform 140 of FIG. 1.

With reference to FIG. 6, method 600 illustrates example functions used by various embodiments. Although specific function blocks (“blocks”) are disclosed in method 600, such blocks are examples. That is, embodiments are well suited to performing various other blocks or variations of the blocks recited in method 600. It is appreciated that the blocks in method 600 may be performed in an order different than presented, and that not all of the blocks in method 600 may be performed.

Method 600 begins at block 610, where the processing logic receives a notification that data has been uploaded to a data storage system. In some examples, the processing logic may be located at a serverless platform that is external to the data storage system. Upon an upload of data to the data storage system, the data storage system may provide a notification to the serverless platform that the data has been uploaded to the data storage system.

At block 620, the processing logic instantiates a serverless function for anonymizing the data uploaded to the data storage system. The processing logic may also set up a trusted execution environment in which to execute the serverless function and provide the serverless function with credentials (e.g., credentials provided by an end user) to access a private data bucket storing anonymization models (e.g., models uploaded by the end user). The trusted execution environment may be a physically isolated execution environment of a processor. In some examples, a virtual machine, container, or other process may be enabled with a TEE in which the serverless function may be instantiated. For example, a TEE enable virtual machine may execute one or more serverless functions for anonymizing data received from a particular end user. In some examples, the TEE may also be an encrypted environment only accessible by one or more encryption keys associated with the end user.

At block 630, the processing logic retrieves, by the serverless function, a data anonymization model from the data storage system. For example, the serverless function may send a request to the data storage system to access the private data bucket storing the anonymization models. The request may include the credentials for accessing the private data bucket and an identification of the anonymization models to be retrieved. The anonymization models may be selected and retrieved based on the type of data uploaded to the data storage system. In some examples, the serverless function may identify the type of data uploaded and retrieve one or more models for anonymizing the type of data. For example, if the data type is an image received from an automated vehicle, the serverless function may retrieve one or more machine learning models to identify and anonymize certain information or portions of the image.

At block 640, the processing logic retrieves the data uploaded to the storage system. The serverless function may be executed by a system external to the storage system and may therefore retrieve the uploaded data from the storage system. In one example, the serverless function may intercept the uploaded data prior to storing the data at the storage system. In other examples, the serverless function may retrieve the data from a temporary data bucket (e.g., in memory, short term storage, etc.) of the data storage system.

At block 650, the processing logic anonymizes, by the serverless function, the data using the data anonymization model to generate anonymized data. The anonymized data may be the uploaded data with sensitive information removed from the data. The original uploaded data may be deleted to prevent the sensitive information from being stored at the data storage system.

At block 660, the processing logic stores the anonymized data to the data storage system. The processing logic may store the anonymized data in one or more data buckets associated with the end user that uploaded the data. For example, the end user may have an account with one or more data buckets allocated to be used by the end user to which the anonymized data is stored. Therefore, all the data stored at the data storage system can be completely anonymized prior to being stored, thus ensuring the privacy of sensitive information.

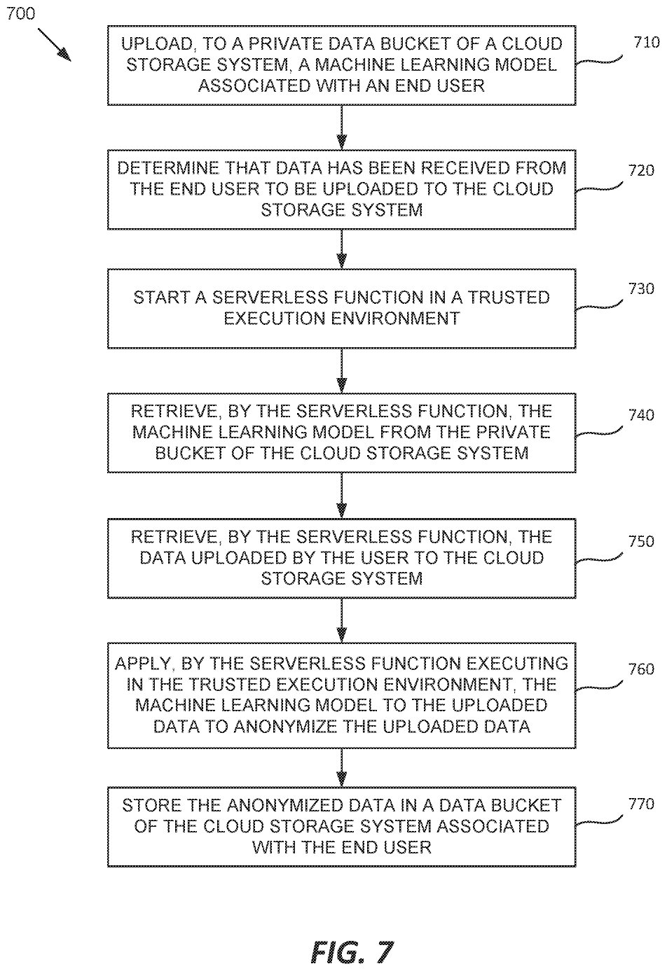

FIG. 7 is a flow diagram of a method 700 of secure and scalable data anonymization and data protection in a data storage system, in accordance with some embodiments. Method 700 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, at least a portion of method 700 may be performed by anonymization service 115 of privacy preservation platform 140 of FIG. 1.

With reference to FIG. 7, method 700 illustrates example functions used by various embodiments. Although specific function blocks (“blocks”) are disclosed in method 700, such blocks are examples. That is, embodiments are well suited to performing various other blocks or variations of the blocks recited in method 700. It is appreciated that the blocks in method 700 may be performed in an order different than presented, and that not all of the blocks in method 700 may be performed.

Method 700 begins at block 710, where the processing logic uploads, to a private data bucket of a cloud storage system, a machine learning model associated with an end user. In some embodiments, an end user may be an entity that uploads data to the cloud storage system. The entity may train one or more machine learning models or other method of anonymization that are proprietary and/or include valuable, private, or sensitive business information associated with the entity that should be kept confidential. Therefore, the processing logic stores the machine learning model and associated data in a private data bucket of the cloud storage system. The private data bucket may be a portion of the cloud storage system that can only be accessed via credentials and/or encryption keys provided by the end user. In some examples, only the end user can access the private data bucket (e.g., via credentials provided by the end user).

At block 720, the processing logic determines that data has been received from the end user to be uploaded to the cloud storage system. For example, an agent, a software module, or any other processing logic associated with the data cloud storage system may identify and determine that data has been uploaded to the cloud storage system. In some examples, an agent on a client device from which data is being uploaded may identify that data is being uploaded to the data storage system and direct the data to an anonymization service as described below, rather than providing the data directly to the cloud storage system. In some examples, the data may be uploaded to a data entry-point of the cloud storage system (e.g., via an API or the like) at which point a notification may be provided to an external data privacy preservation platform that new data has been uploaded to the cloud storage system. In some examples, the data privacy preservation platform may be internal to the cloud storage system.

At block 730, the processing logic starts a serverless function in a trusted execution environment (TEE). In some examples, the processing logic (e.g., the data privacy preservation platform) may first receive or retrieve end user supplied encryption keys for generating a TEE. The processing logic may then generate one or more TEE enabled virtual machines, containers, processes, etc. using the encryption keys. The serverless function may then be invoked within the TEE enabled environment. In some examples, the processing logic may invoke multiple serverless functions to scale the anonymization of data as needed (e.g., corresponding to the amount of data uploaded that is to be anonymized). A TEE may be an isolated processing environment, both physical isolation and encrypted isolation, that protects data being processed from external access or invasion.

At block 740, the processing logic retrieves, by the serverless function, the machine learning model from the private bucket of the cloud storage system. For example, the serverless function may be provided, by the data privacy preservation platform, the end user credentials to the private data bucket. The serverless function may then retrieve the machine learning model from the private bucket using the end user credentials. In some examples, the serverless function may retrieve one or more particular machine learning models for anonymizing information associated with the type of data uploaded to the cloud storage system. For example, if the data object is an image, then machine learning models for removing sensitive information from an image may be retrieved, if the data object is a .pdf file then one or more machine learning models for removing private information from a .pdf file may be retrieved, and so forth.

At block 750, the processing logic retrieves, by the serverless function, the data uploaded by the end user to the cloud storage system. In some examples, the serverless function may retrieve the data from a buffer of the cloud storage system. In some examples, the serverless function may retrieve the data from a temporary data bucket (e.g., in memory) of the cloud storage system.

At block 760, the processing logic applies, by the serverless function executing in the trusted execution environment, the machine learning model to the uploaded data to anonymize the uploaded data. For example, the serverless function may execute the machine learning model within the TEE and input the uploaded data into the machine learning model to identify and/or anonymize private and sensitive data within the uploaded data. At block 770, the processing logic stores the anonymized data in a data bucket of the cloud storage system associated with the user. In some examples, the serverless function may delete the original data that was not anonymized and then store the anonymized data in the cloud storage system. Therefore, the uploaded data is not stored at the cloud storage system until it has been anonymized by the serverless function.

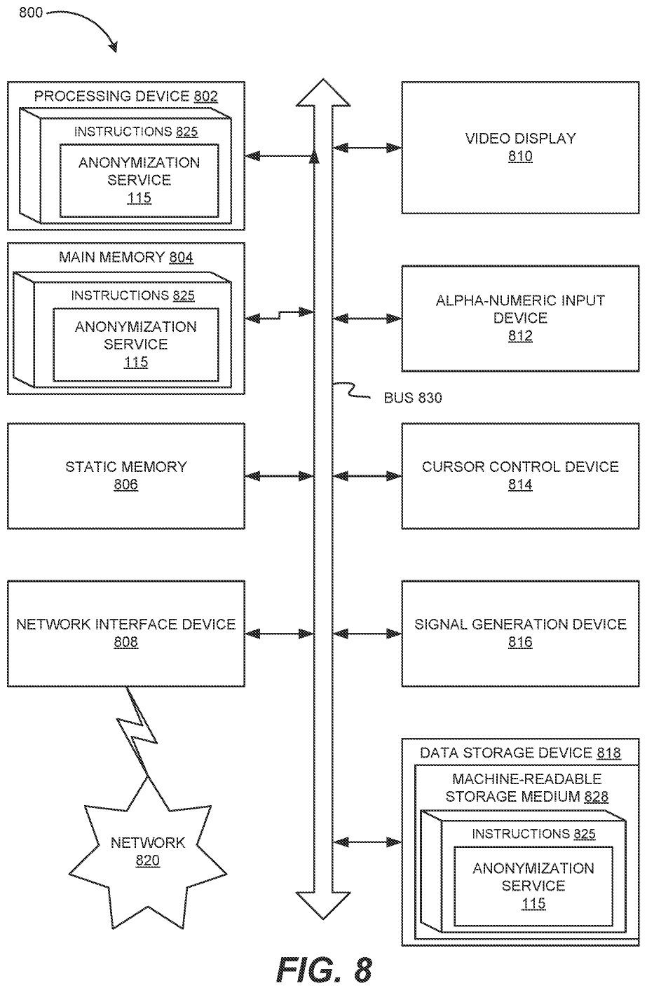

FIG. 8 is a block diagram of an example computing device 800 that may perform one or more of the operations described herein, in accordance with some embodiments. Computing device 800 may be connected to other computing devices in a LAN, an intranet, an extranet, and/or the Internet. The computing device may operate in the capacity of a server machine in client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 800 may include a processing device (e.g., a general purpose processor, a PLD, etc.) 802, a main memory 804 (e.g., synchronous dynamic random access memory (DRAM), read-only memory (ROM)), a static memory 806 (e.g., flash memory and a data storage device 818), which may communicate with each other via a bus 830.

Processing device 802 may be provided by one or more general-purpose processing devices such as a microprocessor, central processing unit, or the like. In an illustrative example, processing device 802 may comprise a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 802 may also comprise one or more special-purpose processing devices such as an application specific integrated circuit (ASIC), a field programmable gate array (FPGA), a digital signal processor (DSP), network processor, or the like. The processing device 802 may be configured to execute the operations described herein, in accordance with one or more aspects of the present disclosure, for performing the operations and steps discussed herein.

Computing device 800 may further include a network interface device 808 which may communicate with a network 820. The computing device 800 also may include a video display unit 810 (e.g., a liquid crystal display (LCD) or a cathode ray tube (CRT)), an alphanumeric input device 812 (e.g., a keyboard), a cursor control device 814 (e.g., a mouse) and an acoustic signal generation device 816 (e.g., a speaker). In one embodiment, video display unit 810, alphanumeric input device 812, and cursor control device 814 may be combined into a single component or device (e.g., an LCD touch screen).

Data storage device 818 may include a computer-readable storage medium 828 on which may be stored one or more sets of instructions 825 that may include instructions for an anonymization service, e.g., anonymization service 115 for carrying out the operations described herein, in accordance with one or more aspects of the present disclosure. Instructions 825 may also reside, completely or at least partially, within main memory 804 and/or within processing device 802 during execution thereof by computing device 800, main memory 804 and processing device 802 also constituting computer-readable media. The instructions 825 may further be transmitted or received over a network 820 via network interface device 808.

While computer-readable storage medium 828 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media and magnetic media.

Example 1 is a method including receiving data uploaded to a storage system from a client device, in response to receiving the data, instantiating a serverless function for anonymizing the data uploaded to the storage system, retrieving, by the serverless function, an anonymization model to anonymize the data uploaded to the storage system, and applying, by the serverless function, the anonymization model to the data uploaded to the storage system to generate anonymized data.

Example 2 is the method of Example 1, further including storing the anonymized data to a data bucket associated with the client device.

Example 3 is the method of Example 1 or Example 2, wherein the anonymization model is a machine learning model.

Example 4 is the method of Example 1, Example 2, or Example 3, wherein the machine learning model is trained to anonymize a type of data associated with the data uploaded to the storage system.

Example 5 is the method of Example 1, Example 2, Example 3, or Example 4, wherein the anonymization model is stored in a private domain of the storage system.

Example 6 is the method of Example 1, Example 2, Example 3, Example 4, or Example 5, wherein the storage system comprises a cloud storage system.

Example 7 is the method of Example 1, Example 2, Example 3, Example 4, Example 5, or Example 6, wherein the serverless function is executed in an isolated execution environment.

Example 8 a system including a memory and a processing device, operatively coupled to the memory, to receive a notification that data has been uploaded to a storage system, instantiate a serverless function for anonymizing the data uploaded to the storage system, retrieve, by the serverless function, an anonymization model from the storage system, retrieve the data uploaded to the storage system, anonymize, by the serverless function, the data using the anonymization model to generate anonymized data, and store the anonymized data to the storage system.

Example 9 is the system of Example 8, wherein the anonymization model is a machine learning model for anonymizing a type of data associated with the data uploaded to the storage system.

Example 10 is the system of Example 8, or Example 9, wherein the serverless function is executed within a trusted execution environment.

Example 11 is the system of Example 8, Example 9, or Example 10, wherein the serverless function retrieves the anonymization model from a private storage bucket of the storage system.

Example 12 is the system of Example 8, Example 9, Example 10, or Example 11, wherein the serverless function retrieves the data from a temporary storage bucket of the storage system.

Example 13 is the system of Example 8, Example 9, Example 10, Example 11, or Example 12, wherein the storage system is a cloud storage system comprising one or more storage buckets.

Example 14 is the system of Example 8, Example 9, Example 10, Example 11, Example 12, or Example 13, wherein the serverless function retrieves and anonymizes the data prior to storing the data to the storage system.

Example 15 is a non-transitory computer-readable storage medium including instructions that, when executed by a processing device, cause the processing device to determine that data has been uploaded to a cloud storage system, start an anonymization service for anonymizing the data, and apply, by the anonymization service, an anonymization model to the data.

Example 16 is the non-transitory computer-readable storage medium of Example 15, wherein the processing device is further to store the data, as anonymized, at the cloud storage system.

Example 17 is the non-transitory computer-readable storage medium of Example 15 or Example 16, wherein the data is redirected to the anonymization service prior to being stored at the cloud storage system.

Example 18 is the non-transitory computer-readable storage medium of Example 15, Example 16, or Example 17, wherein the processing device is further to retrieve the anonymization model from the cloud storage system.

Example 19 is the non-transitory computer-readable storage medium of Example 15, Example 16, Example 17, or Example 18, wherein the processing device is further to retrieve, by the anonymization service, the data from a temporary data bucket of the cloud storage system.

Example 20 is the non-transitory computer-readable storage medium of Example 15, Example 16, Example 17, Example 18, or Example 19, wherein the anonymization model is stored in a private domain accessible only by the anonymization service.

Example 21 is a method including uploading a machine learning model to a private data bucket of a cloud storage system, determining that data has been received by the cloud storage system from an end user, starting a serverless function in a TEE, retrieving, by the serverless function, the machine learning model from the private bucket of the cloud storage system, retrieving the data uploaded by the end user, and applying the machine learning model to the uploaded data to anonymize the uploaded data.

Example 22 is the method of Example 21, further including storing the anonymized data in a data bucket of the cloud storage system associated with the end user.

Example 23 is the method of Example 21 or Example 22, wherein the machine learning model identified and removes one or more sensitive portions of the uploaded data.

Example 24 is the method of Example 21, Example, 22, or Example 23, wherein the serverless function is instantiated in a TEE of a virtual machine.

Example 25 is the method of Example 21, Example, 22, Example 23, or Example 24, wherein the serverless function uses credentials provided by the end user to access the machine learning model in the private bucket of the cloud storage system.

Example 26 is the method of Example 21, Example, 22, Example 23, Example 24, or Example 25, further including storing the data uploaded to the cloud storage system in a temporary data bucket of the cloud storage system.

Example 27 is the method of Example 21, Example, 22, Example 23, Example 24, Example 25, or Example 26, wherein the temporary data bucket is located in a memory or a data buffer of the cloud storage system.

Example 28 is an apparatus including means for receiving a notification that data has been uploaded to a storage system, means for instantiating a serverless function for anonymizing the data uploaded to the storage system, means for retrieving, by the serverless function, an anonymization model, means for anonymizing, by the serverless function, the data using the anonymization model to generate anonymized data, and means for storing the anonymized data to the storage system.

Example 29 is the apparatus of Example 28, wherein the means for anonymizing the data comprises a machine learning model associated with a type of the data uploaded to the storage system.

Example 30 is the apparatus of Example 28 or Example 29, further including means for retrieving the data from the storage system to be anonymized by the anonymization model.

Example 31 is the apparatus of Example 28, Example 29, or Example 30, further including means for generating a virtual execution environment enabled with a trusted execution environment and means for instantiating the serverless function within the trusted execution environment of the virtual execution environment.

Example 32 is the apparatus of Example 28, Example 29, Example 30, or

Example 31, wherein the anonymization model is a machine learning model.

Example 33 is the apparatus of Example 28, Example 29, Example 30, Example 31, or Example 32, wherein the anonymization model is a machine learning model trained to detect and remove a type of data associated with the data uploaded to the storage system.

Example 34 is the apparatus of Example 28, Example 29, Example 30, Example 31, Example 32, or Example 33, wherein the anonymization model is stored in a private domain of the storage system.

Example 35 is the apparatus of Example 28, Example 29, Example 30, Example 31, Example 32, or Example 33, or Example 34, wherein the storage system comprises a cloud storage system.

Unless specifically stated otherwise, terms such as “receiving,” “routing,” “updating,” “providing,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A method comprising:
receiving data uploaded to a storage system from a client device;
in response to receiving the data, instantiating a serverless function for anonymizing the data uploaded to the storage system;
retrieving, by a processing device executing the serverless function, an anonymization model to anonymize the data uploaded to the storage system; and
applying, by the processing device executing the serverless function, the anonymization model to the data uploaded to the storage system to generate anonymized data.

2. The method of claim 1, further comprising:
storing the anonymized data to a data bucket associated with the client device.

3. The method of claim 1, wherein the anonymization model is a machine learning model.

4. The method of claim 3, wherein the machine learning model is trained to anonymize a type of data associated with the data uploaded to the storage system.

5. The method of claim 1, wherein the anonymization model is stored in a private domain of the storage system.

6. The method of claim 1, wherein the storage system comprises a cloud storage system.

7. The method of claim 1, wherein the serverless function is executed in an isolated execution environment.

8. A system comprising:
a memory; and
a processing device, operatively coupled to the memory, to:
receive a notification that data has been uploaded to a storage system;
instantiate a serverless function for anonymizing the data uploaded to the storage system;
retrieve, by the serverless function, an anonymization model from the storage system;
retrieve the data uploaded to the storage system;
anonymize, by the serverless function, the data using the anonymization model to generate anonymized data; and
store the anonymized data to the storage system.

9. The system of claim 8, wherein the anonymization model is a machine learning model for anonymizing a type of data associated with the data uploaded to the storage system.

10. The system of claim 8, wherein the serverless function is executed within a trusted execution environment.

11. The system of claim 8, wherein the serverless function retrieves the anonymization model from a private storage bucket of the storage system.

12. The system of claim 8, wherein the serverless function retrieves the data from a temporary storage bucket of the storage system.

13. The system of claim 8, wherein the storage system is a cloud storage system comprising one or more storage buckets.

14. The system of claim 8, wherein the serverless function retrieves and anonymizes the data prior to storing the data to the storage system.

15. A non-transitory computer readable storage medium including instructions stored therein, that when executed by a processing device, cause the processing device to:
determine that data has been uploaded to a cloud storage system;
start an anonymization service for anonymizing the data; and
apply, by the processing device executing the anonymization service, an anonymization model to the data.

16. The non-transitory computer readable storage medium of claim 15, wherein the processing device is further to:
store the data, as anonymized, at the cloud storage system.

17. The non-transitory computer readable storage medium of claim 16, wherein the data is redirected to the anonymization service prior to being stored at the cloud storage system.

18. The non-transitory computer readable storage medium of claim 15, wherein the processing device is further to:
retrieve the anonymization model from the cloud storage system.

19. The non-transitory computer readable storage medium of claim 15, wherein the processing device is further to:
retrieve, by the anonymization service, the data from a temporary data bucket of the cloud storage system.

20. The non-transitory computer readable storage medium of claim 15, wherein the anonymization model is stored in a private domain accessible only by the anonymization service.
